(19) United States
(12) Patent Application Publication
(10) Pub. No.: US 2010/0281138 A1
(43) Pub. Date: Nov. 4, 2010

(54) METHOD AND SYSTEM FOR REMOTE COPROCESSOR

(76) Inventors: Paulo Lerner Froimtchuk, Rio de Janeiro (BR); Eduardo Sualden Klein, Rio de Janeiro (BR)

Correspondence Address: SMITH, GAMBRELL & RUSSELL, SUITE 3100, PROMENADE II, 1230 PEACHTREE STREET, N.E., ATLANTA, GA, 30309-3592, US

(21) Appl. No.: 12/432,318

(22) Filed: Apr. 29, 2009

(51) Int. Cl. G06F 15/16

(52) U.S. Cl. 709/219

(57) ABSTRACT

A system and method for optimizing data by using a remote processor and a remote server, wherein the invention is able to send the processed and optimized data to a local device in real-time, thus aiming to optimize the data to local device's resources and user experience when accessing the data.

### BACKGROUND OF THE INVENTION

1. Field of the Invention

The present invention discloses a method for optimizing performance of electronic devices by using a remote coprocessor based in a remote server, wherein the remote coprocessor is able to process and optimize data navigating from the internet or other network to the device. Thus aiming to optimize the data according to the local device's resources, reducing the required bandwidth when accessing data, energy consumption and offering a better user experience.

2. Related Art

The technological advancements of the past decade enabled a large amount of people, worldwide, to purchase computers and mobile phones. Also, the evolution of high-speed networks enabled people to freely communicate and exchange data over the internet, generating a huge impact in culture, business and way of life all over the world.

Lately, consumer priorities shifted from functionalities (what the equipment can do) to connectivity and portability (what can be done with the equipment). People want to use their equipment for most common tasks—email, web surfing, video watching—whenever they want and wherever they are, spending less money.

This explains the incredible success of netbooks and smartphones, that are very portable but perform the way regular computers did four to eight years ago. Because of that and in order to save energy those devices have very limited functionalities and prevent users from having full access to the internet's content.

Technologies currently available impose a clear tradeoff between portability and functionality for consumers. Ideally, users want smaller and more portable devices to be used for practically any purpose, whenever they want, and still have satisfactory processing and energy performance.

However, in order to increase the usage of electronic equipments, improve efficiency and portability, the company believes that heavily demanding tasks will have to be outsourced. The present invention proposes a solution for this problem without the need of adding extra components to the product, adding costs and non-recurring-engineering. It can be offered to most of the devices available in the market.

Document WO 01/80036 discloses a method for real time websites translations through a proxy server. Although the method described in this document allows the correct content visualization by means of real-time data processing on a remote server/computer, this document does not address the problem of lack of resources and performance of portable devices and methods to solve it. The invention also does not take into consideration the energy consumption and internet bandwidth.

Document US 2008/249969 describes an intelligent agent for mobile devices, which analyze the contextual information from many sources to determine more accurately which remote utilities and services make available to the user. The invention also intends to predict the user's next steps in order to initiate some processes before the user does it himself facilitating the performance of some actions and combines several remote utilities and information sources in order to offer accurate and optimized mobile device content, services and applications. Besides, the document does not change the content, optimizing it, but it only analyzes it in order to provide the user with related information.

Document U.S. Pat. No. 6,563,517 B1 describes methods, devices and systems for dynamically adjusting transcoding parameters so as to increase the benefits of transcoding. The invention designs methods of adaptation to cope with the variability of network characteristics and of the size of transcoded images. It also provides a way to the local device interact with a proxy server continuously through a slide bar. Although the method described in this document allows the correct content visualization by means of real-time data processing on a remote server/computer, this document does not address the problem of scalability of the remote server/computer and only considers image processing and not every media type, like videos, compressed files, pdfs, text files and specific software format files. The invention also does not take into consideration the energy consumption, real time and efficient processing data and is completely CPU-based, differently from this invention as it will be presented further.

Document U.S. Pat. No. 6,457,030 B1 discloses systems, methods and computer program products for modifying web content files, such as HTML files, for display via pervasive computing devices that have smaller displays and various performance limitations compared with desktop computing devices. Although the method described in this document allows the correct content visualization by means of real-time data processing on a remote server/computer, this document does not address the problem of scalability of the remote server/computer. The invention also does not take into consideration the energy consumption and real time and efficient processing data.

All the documents above only consider HTTP, HTTPS protocols. The present invention will treat also the FTP, POP and IMAP protocols, enabling users not only navigate through the internet, but also download and view files via FTP, e-mail attachments and backup servers. They also do not present methods to allow the user to download only part of a document instead of downloading a whole file in order to preview it. Therefore, there is an unmet need to improve the processing capabilities of portable devices while diminishing power consumption and bandwidth usage in a scalable, efficient and real time manner.

### BRIEF SUMMARY OF THE INVENTION

The present invention presents a solution for the problem of lack of processing power of electronic devices, mainly portable devices such as mobile phones and netbooks, by providing a method and system for intercepting communication between the device and the network and process the data in real-time in order to make it optimized for the device.

It is thus an object of the invention a method for remote and real-time data optimization comprising the steps of:
a) sending a local device's data request to a remote server;
b) the remote server forwards the request to the network and waits for the response; and
c) optimization of the response by processing it on the remote processor and sending to the local device the optimized data by the remote server,
wherein the sending of optimized information to the local device is done in real-time with the optimization.

It is a further object of the invention a system for remote and real-time data processing comprising:
a) a local device;
b) a remote server;
c) a remote processor
d) the network; and
e) data to be optimized;
wherein:
   the local device's data access is done via the remote server; and
   the remote processor performs optimization to deliver the data to the local device in an optimized format.

These and several other objects of the invention will be better explained by the detailed description below.

### BRIEF DESCRIPTION OF THE DRAWINGS

FIG. 1 depicts a simplified schema showing the common connection between the local device 101 and the internet 102.

FIG. 2 shows the flowchart of the processing performed by the local device upon access to a URL. From this diagram it can be seen that when a URL is not compatible with the device, an error message is sent to the user.

FIG. 3 shows the simplified schema of the solution of the present invention, where the local device 301 is connected to the internet 303 by means of a remote server 302. The remote server is a server in communication with a remote processor, which has improved processing capabilities.

FIG. 4 shows in details a preferred embodiment of a remote processor 400. It preferably has FPGAs 401, GPUs 402, ASICs 403, and multicore processors 402, that can perform the processing needed to format the data to the local device's configuration.

FIG. 5 shows the flowchart of operations performed by the remote processor.

FIG. 6 shows a flowchart of a preferred embodiment comprising the authentication and logon of a user in the remote server and the remote processor, and the update of a billing system in a pay-per-use mode.

FIG. 7 shows the flowchart of the processing performed by the schema of FIG. 3. In this process, if the URL response is not compatible with the local device, the remote server sends the data to the remote processor, which then processes the data and optimizes it to the local device, sending the output in real-time to the user.

FIG. 8 shows an example of how the system of the present invention processes a website.

FIG. 9 shows an example of how the system of the present invention performs when a link to a video is followed.

FIG. 10 shows an example of how the system of the present invention processes an image.

FIG. 11 shows an example of how the system of the present invention processes a compressed file.

FIG. 12 shows an example of how the system of the present invention previews a file.

FIG. 13 shows an example of how the system of the present invention processes an e-mail message and attachment.

FIG. 14 shows an example of a cache algorithm useful in the present invention.

FIG. 15 shows an example of a user accessing several files on a remote backup server over the internet.

FIG. 16 shows an example of multiple instances of the remote server.

FIGS. 17-21 shows examples of a local device GUI executing the system of the present invention.

### DETAILED DESCRIPTION OF PREFERRED EMBODIMENTS

The examples disclosed herein are embodiments of the invention with illustrative purpose only, and not restrictive. All other possible embodiments, encompassed by the concept of the invention should be understood as within the scope of the present invention.

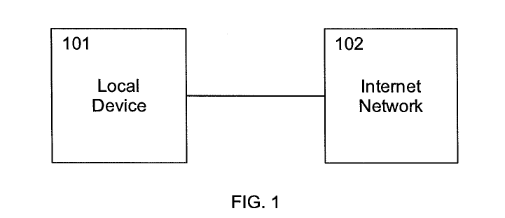

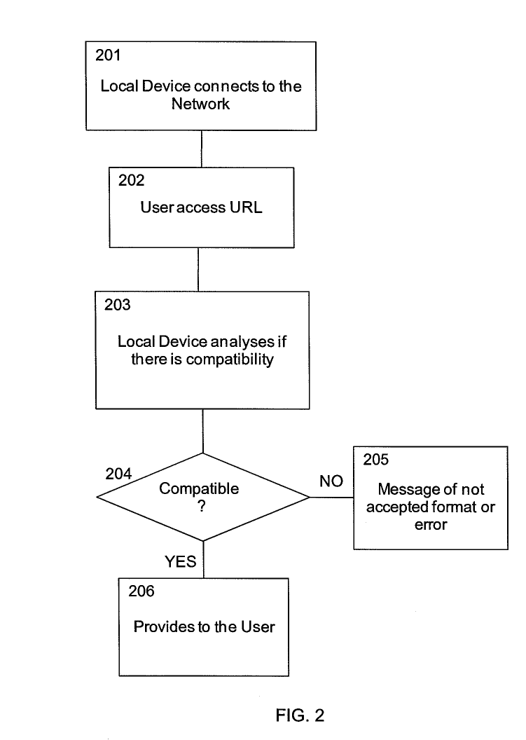

The limited resources of electronic devices, such as notebooks, netbooks and smartphones, do not allow data to be accessed, exhibited or executed properly. The current connection schema available is shown in FIG. 1. In this figure, the local device (101) connects directly to the internet or any other network (102). This connection is detailed in FIG. 2. The local device, which has limited processing capabilities, connects to the network (201) and the user then access the desired data, for example an URL (202) and the local device performs an analysis to decide if the content to be accessed is compatible to the available resources (203). A simple output is generated, as an error message (205) informing the problem encountered or as access to the information (206), in case the device can exhibit the accessed content.

Data Optimization System

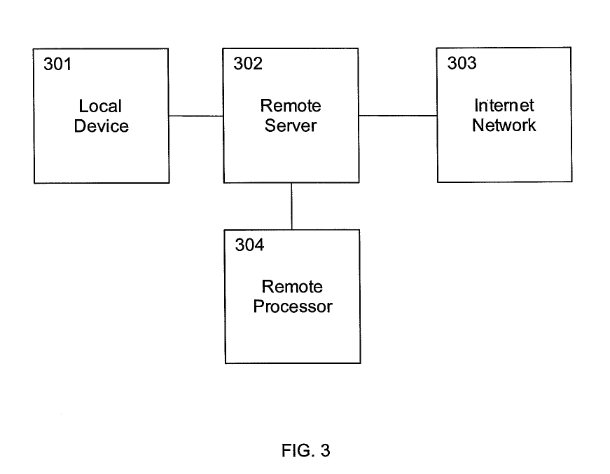

The present invention aims to overcome the compatibility issue of devices when accessing data from the internet or any other location that is not natively formatted to the local device capabilities by means of a data optimization method and system. The system can be summarized in FIG. 3, and the optimization can be performed by adding a remote server (302) to intermediate and monitors the communication between the local device (301) and the internet (303), wherein the remote server (302) benefits from the processing capabilities of a powerful remote processor (304). The system of the present invention is a system comprising:
a) a local device;
b) a remote server;
c) a remote processor;
d) the network; and
e) data to be optimized;
wherein:
the local device's data access is done via the remote server; and
the remote processor performs optimization to deliver the data to the local device in an optimized format in real-time.

Local Device

The local device should be understood as a device with limited processing capabilities, i.e., a device without enough processing power to perform all activities desired by the user.

Suitable examples of local devices include, without limiting desktop computers, notebooks, netbooks, smartphones and cell phones. Preferred devices include netbooks and cell phones and smartphones.

Remote Server

The remote server acts mainly as a proxy, receiving the request of the local device, accessing the data and filtering it according to the local device limitation. When it finds data that can be optimized, it sends it to the remote processor.

The remote server is responsible for communicating with the local device, the network and with the remote processor. It receives data from the local device, forwards it to the network, analyzes the response and decides whether it should send it back directly to the local device or if it should be processed before by the remote processor. The remote server should also authenticate every local device so as the user could use the service. The communication of the remote server and the network can be performed by several communication protocols known in the art, such as HTTP, HTTPS, FTP, IMAP, POP, among others.

The remote server must also send an HTML command to the local device in case there are format changes in some files so as the local device will be able to receive and visualize it correctly. For example, if there is a link with a .wmv video and the local device only accepts .mp4 videos, the remote processor will convert it from .wmv to .mp4. In this case, the request sent by the local device is a .wmv video, so it will expect to receive a .wmv. If the remote server sends back a .mp4, it may not work in some devices. To avoid this situation and correct mistakes, the remote server will send a command to force the local device to request a .mp4 video so when it receives, it will work properly. This step is not included in any of the prior art related inventions and is essential for the functioning of the current service. Many portable devices (example: iPhone) will not work properly if the response has not the same file formats of the request. This is valid for all the examples described further, but for the sake of brevity, this step will be omitted to facilitate the understanding of each example.

The communication between the local device and the remote server will be secure and must be authenticated every time the local device connects to the remote server.

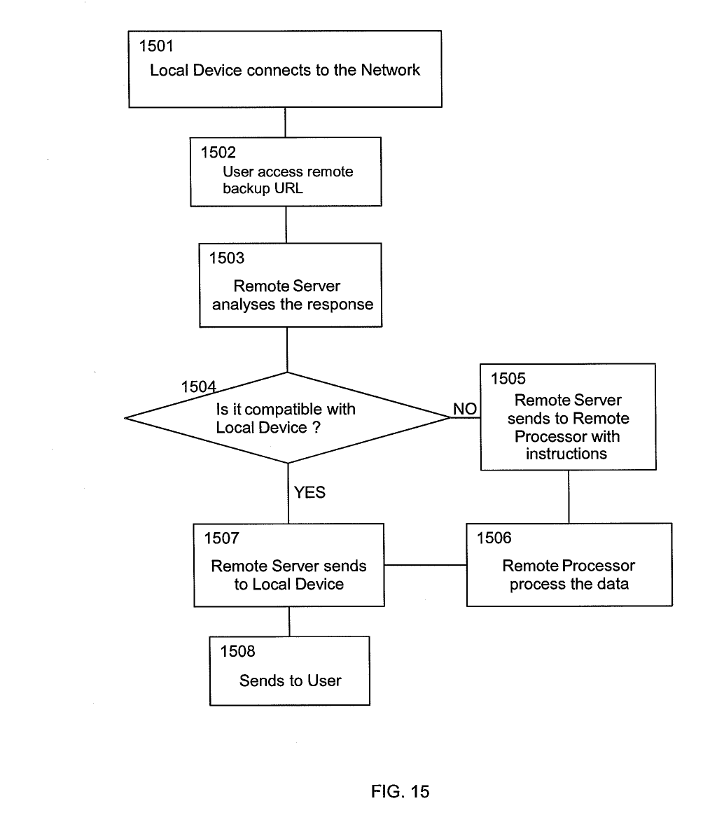

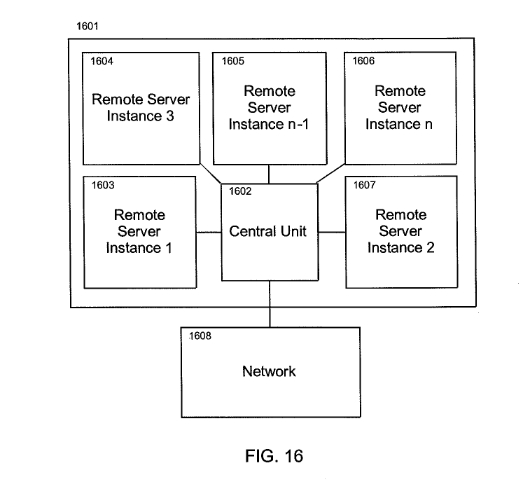

The remote server can also be composed by several remote server instances, each one taking care of many different processes. There is no limit on how many instances a remote server might have. One example of a remote server with multiple instances is shown in FIG. 15, where a central unit acts as a bridge between the network and the remote server instances. By process, it should be understood the communication with the local device, network, and the communication to a remote processor. This enables to a fast and easy scalable manner to increase the number of served local devices, just adding remote server instances. The central unit (1502) controls the traffic and distributes it through the remote server (1503 to 1507) instances. The central unit will have a parameter that will indicate how many instances are present in order to control the data. In a preferable embodiment, a remote server instance is a multicore processor, not limited to it.

As storage is cheaper than bandwidth and processing power, the remote server is responsible for minimizing the required bandwidth and amount of processing instructions by storing some of the processed data.

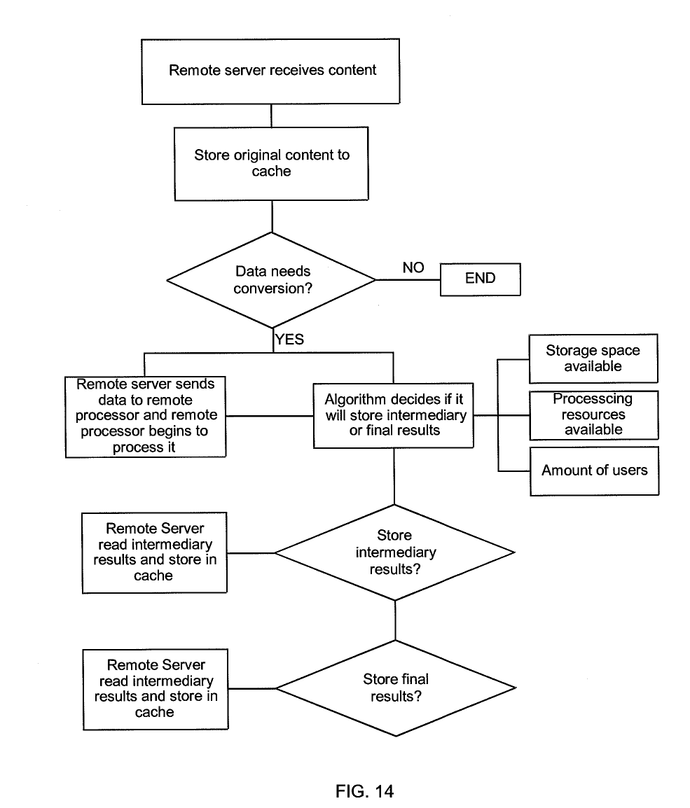

The remote server may also include a cache to store the most frequently accessed content. In a preferred embodiment of the present invention it is shown a cache storing algorithm in FIG. 14. The remote server will store the original data as a normal proxy as well as intermediate processed data or final processed data to different specific devices. This will avoid reprocessing the same data to the same device many times, reducing the processing needs and the load in the remote processor. Doing so enables a higher user per server ratio and consequently a lower cost per user.

The decision about storing the original or intermediate or final data will be made by the remote server according to a proprietary algorithm that correlates the storage space available, the computing resources necessary and the amount of users accessing the same content.

When the remote server detects that some content is being accessed many times, it will automatically send an instruction to process it for every device during the remote processor idle time. This allows less latency and avoids real time processing when another type of local device requests the same content, once it will have already been processed.

The system includes a ranking method for websites that according to its popularity, places the address in a position that will make its content more likely to be stored.

The system also includes a video comparator which identifies identical videos in the internet in different locations and different names in order to avoid processing it twice if there is already one of them in cache. The algorithm is based on many characteristics such as location, name, size, author, created date, last modified data and frames comparison tool. If the algorithm identifies that the video already exists in the desired format in the cache, it will recover this one instead of processing the one requested by the user.

Each remote server controls a content list with all the processed files and formats and updates a central list available to all remote servers. Before sending a processing instruction to the remote processor, the remote server accesses the content list and check if the file is already available. If it is available, the remote server gets it from the cache and sends it to the local device.

The remote servers' instances will share their list of contents in order to share their cache whenever possible.

The most accessed web pages will have their content processed every time the system detects changes, even before any request to the new content. This will be handled by an intelligent predictor based on the number of users that access the web pages.

Usually, the webpage's codes will be stored on their original form, because they are mostly composed by text and don't demand neither a lot of processing nor a lot of storage space. The intermediate and final caches will be applicable mainly, but not limited, to images, videos and documents, which demand heavy processing power and huge storage resources. For example, if there is a lot of space available for storage and most of the resources are in use, it is worth to store the final data to avoid any other processing. This method will also contribute to an easily self-adaptive scalable system.

In order to maximize performance, diminish bandwidth costs and investment the Remote Server may be installed in the telecom operator/carrier that is offering the service to its users.

Remote Processor

The remote processor is an array of equipments with enough processing power to execute the tasks requested by hundreds of local devices in an adequate amount of time. It optimizes data through a stream processor, so as to allow the local device to have adequate access to it.

The remote processor has a pre-configured infrastructure using FPGA, ASICs, GPUs and multicore processors, not being limited to these ones and not containing obligatorily all of them, capable of processing the required data at any moment. Regarding the FPGA, it means that it is configured to some specific tasks. Regarding the GPUs and multicore processors, it means that they have a set of instructions that will be repeated, changing only the data. This allows for a faster processing of the tasks, since only the data changes all the time.

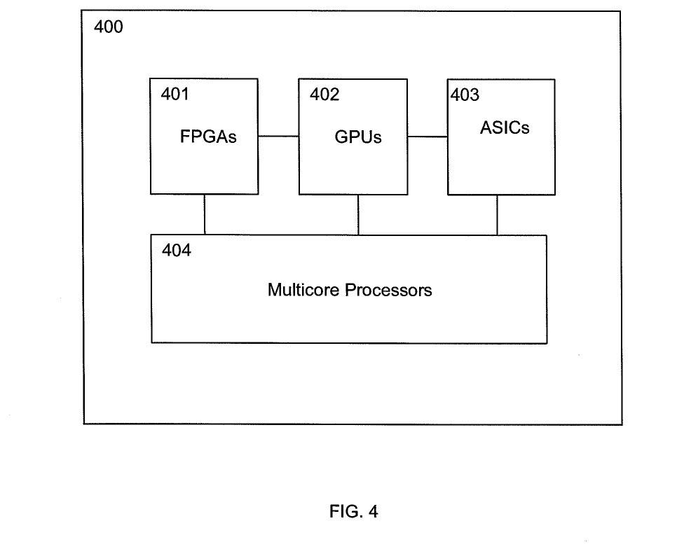

An example of a suitable remote processor is shown in FIG. 4, wherein the remote processor (400) is composed of chips such as FPGA (401), ASIC (403), GPU (402) and multicore processor (404), therefore increasing speed and processing power, and also allowing several tasks to be performed simultaneously by the remote processor (400).

The remote processor has also a control unit, preferably a multicore processor, which receives instructions from the remote server instance and distributes the tasks between the FPGAs, ASICs, GPUs and multicore processors.

In the case some processing tasks may be demanded more than others, the remote processor will change dynamically the FPGA configuration and the GPU and multicore processors' instructions. This is done by a self adaptive control that reconfigures the remote processor capabilities according to the task to be performed. This way, the number of remote processors is minimized and the efficiency is higher, achieving a higher rate of users per server.

In this way, the remote processor will be always able to process every data in real time, without running out of resources, independently of the type of processing executed. Besides, when new standards and formats become available, the remote processor will be ready to include them into its resources easily.

On the other hand, if there is not a lot of data being processed, parts of the remote processor may be disabled to reduce energy consumption.

As soon as the remote server begins to receive the data, it verifies if it needs to be optimized. If this is the case, it will send the initial received data to the remote processor, without waiting to receive all the data. The remote processor processes every data it receives and immediately sends it back to the remote server in order to send to the local device. It is well known that, over the internet, data is divided into packets and these packets are transmitted sequentially. Therefore, the remote processor does not need to receive all the packets in order to begin the optimization—as soon as a packet is received, it is optimized, and as soon as a packet is optimized, it is forwarded to the local device. This dynamic process is well known by those skilled in the art as pipeline and allows for a real time and efficient data processing.

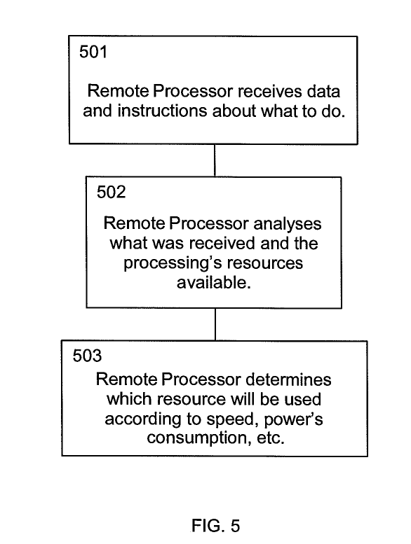

The process by which the remote processor optimizes the data is explained in FIG. 5. The remote server sends the data and instructions that the remote processor should perform (501). Then, the remote processor analyzes the data received and which resources are available to perform the task (502), deciding which resources will be used to optimize the data in view of the local device configuration (503).

The remote processor may communicate with the remote server through a different protocol, comparing to the protocol the remote server will communicate with the local device and the network.

Data

The data to be accessed is data stored in digital format in server distributed all over the world in the network. Suitable examples of digital data according to this invention include, without limiting, documents, pictures, videos, websites, compressed files, e-mails, music and any other information that can be stored and accessed by the local device over a network.

Data Optimization Method

The data optimization method of the present invention is a method comprising the following steps:
a) sending a local device's data request to a remote server;
b) the remote server forwards the request to the network and waits for the response; and
c) optimization of the response, containing the data, by processing it on the remote processor and sending to the local device the optimized data by the remote server,
wherein the sending of information is done in real-time with the optimization.

The request of the local device is composed mainly by Location of the said data. Some local devices also send an identifier to the web, but this is not obligatory.

Thus, after receiving the request with the location, the remote server and remote processor are able to fetch the correct data and optimize it to the local device processing capabilities, in order to ensure a correct and optimal visualization by the user of the local device and diminish the power consumption and local processing. The request contains only the location of the data and the kind of processing that will be done depends on what is stored in the location.

The optimization process will vary according to the type of data and local device. However, the optimization process will be done to process the data in an adequate format according to the local device settings. Suitable optimization processes include the following:
Video conversion (format and resolution) and streaming
Encryption
Compression and decompression
Virus scan
Network enhancer
Firewall
Image processing
3^{rd} party applications.
Preview of files
Files conversion

In a preferred embodiment, the role of virus scan and firewall can be performed by the remote processor. Thus, local device does not need to spend valuable internal resources for that, increasing its performance.

The optimization process and data access by the local device is orchestrated in real-time, i.e, the local device will access the data faster when compared to a direct access. Preferably, the optimization process will be so fast that the user will not experience any lag.

The channel by which the request is made and the optimized data is sent back to the local device can be any suitable channel, such as modems including regular telephone grade modems, cable modems and DSL modems, ISDN adapters, Ethernet cards, cellular telephone communications systems, and wireless networking systems (e.g., 802.11 a/b/g/n etc). Similarly, the channel by which the remote server accesses the data can be any suitable connection, such as modems including regular telephone grade modems, cable modems and DSL modems, ISDN adapters, Ethernet cards, cellular telephone communications systems, and wireless networking systems. In a preferred embodiment, the local device is connected to the remote server through mobile communications systems.

In a preferred embodiment, in order to access the remote server, the local device user should logon onto the remote server, preferably a proxy server, and inform the remote server what kind of device it is and the kind of data it can process, in order to ensure maximum compatibility and performance.

Suitable parameters to be informed to the remote server include: manufacturer and model number, internet speed access, data compression level, image resolution, video format, video streaming or download.

The identification of the local device can be by any means that ensure its correct identification by the remote server. Suitable means include local device's MAC address or IMEI or serial number.

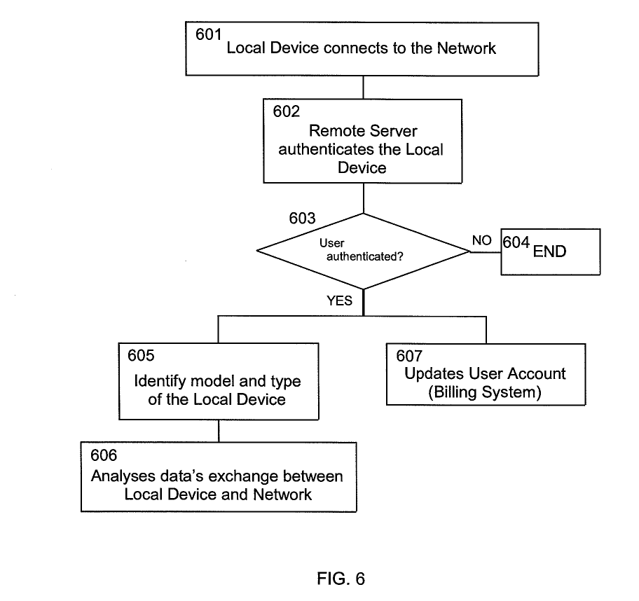

FIG. 6 shows a flowchart of a preferred embodiment of the method of the present invention. Due to the fact that each local device has unique processing capabilities, as soon as the device connects to the network (601) the remote server must authenticate the local device (602), in order to correctly prepare the optimization instructions to the remote server. If authentication (603) succeeds, the remote server and remote processor features become available to the user. Regarding the processing features, the remote server identifies every feature of the local device (605), monitors the local device's data exchange (606) identifying the optimization procedures to be performed if any incompatibility is encountered and remotely processes it in a remote processor. As for the billing system (607), in case the user pays per access, he is charged every time he uses the services. So, after the user's authentication process is complete, his account is updated.

Due to the real-time processing capability, the user will be able to easily surf in the internet and at every request for a new webpage, for example, it will be analyzed by the remote server and optimized by the remote processor to the local device's settings.

If the response to the request contains data that is not optimized for the local device, the present invention will automatically optimize it to the local device, in a real-time processing.

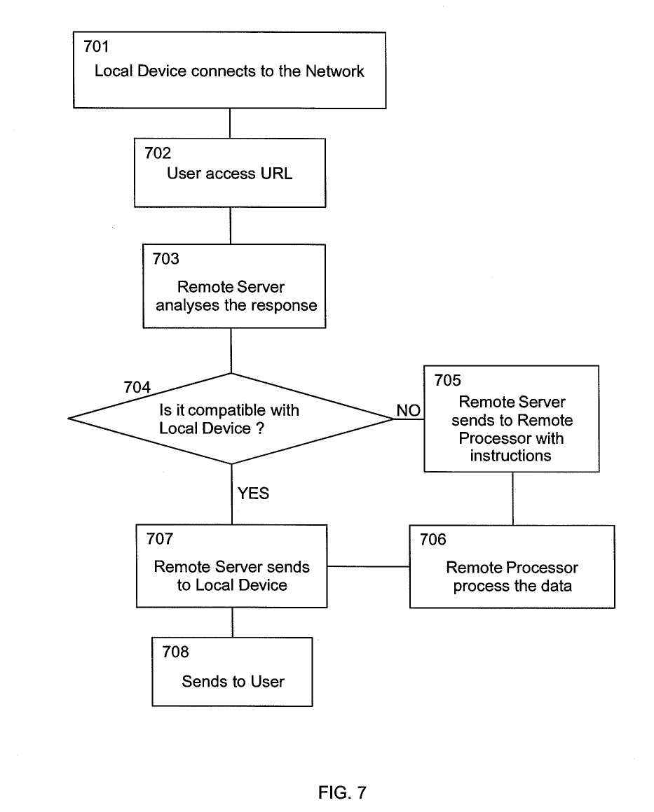

In case no optimization is needed, the remote server just sends the data to the local device automatically without modifications. FIG. 7 provides detailed information on the method of the present invention. The local device, which has limited processing capabilities, connects to the network (701) and the user then access the desired data, for example an URL (702). Then the remote server analyzes the response received from the network (703) and decides if the response is compatible to the available resources (704). In case the answer is negative, i.e. the local device will be unable to correctly display the data; the remote server then sends the data to a remote processor (705) with instructions on how to optimize the data. The optimization (706) process and sending of optimized data to local device (707) are done in real-time. In this embodiment, no error message due to wrong format is generated.

In the case the user is willing to download or preview a big file, the system will proceed in the following way:
a) Local device sends request to the remote server;
b) Remote server receives the request, forwards it to the network; and
c) Remote server sends an HTML command to the local device in other to refresh its request to prepare it to receive the right content format.

This step is not included in any of the related inventions and is essential for the current functioning of the current service. Many portable devices (example: iPhone) will not work properly if the response has not the same file formats of the request.

Instead of downloading a file in order to verify if the content is adequate, user will be able to preview it before. Therefore, the user will only download files that are pertinent and useful, saving bandwidth, time and energy. The process is described in the following way;
a) Remote server sends to the local device a preview of the whole file in order to allow the local device to choose if he wants to download the whole file or only part of it;
b) Local device's user chooses and sends request to the remote server; and
c) Remote server sends the data to be optimized to the remote processor and sends it back to the local device. The remote server sends the data to the remote processor as it receives it without waiting for the end of the data. In the same way, the remote processor does not wait for receiving all the data to process it and sending it back to the remote server. This is known by pipeline for those skilled in the art. This allows for a real time and efficient data processing.

In another embodiment, the local device is accessing the mailbox. In case an e-mail message contains attachments that should be optimized, the remote server will insert a link to the message where the user, by clicking on it, access the data by the method herein described or simply substitutes the attachment for the correct file.

The following section will describe how the user will interact and use the service through examples. The service is not limited to the examples below. Their intention is to illustrate and facilitate the understanding of the invention.

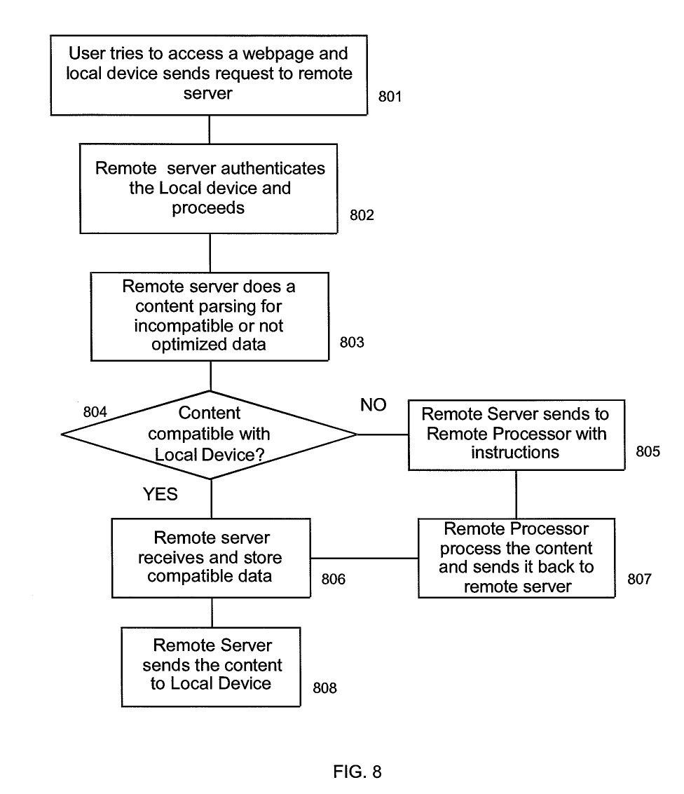

A first example, shown in FIG. 8, is when the user tries to access a webpage and the request is sent to the remote server by the local device (801). The Remote server receives the request, authenticates the user and proceeds with the request (802). Upon receiving of the requested content, the remote server does a content parsing for incompatible or not optimized data (803). If everything is already compatible and optimized (806), the remote server sends the information back to the local device (808) without modification. If there is a video, an image, a flash picture or animation or any other data to be processed, the remote server sends it to the remote processor, along with the processing instructions (805) and the remote processor sends it back to the remote server, which will forward it to the local device (807). If the incompatible data is a video or image, the remote processor will convert it to accepted format and resolution. If it is a flash animation, it will be converted to a video format and if it's a flash picture, it will be converted to an image format. In this case, the local device's user will navigate through the internet normally, without any changes, besides the increase of speed.

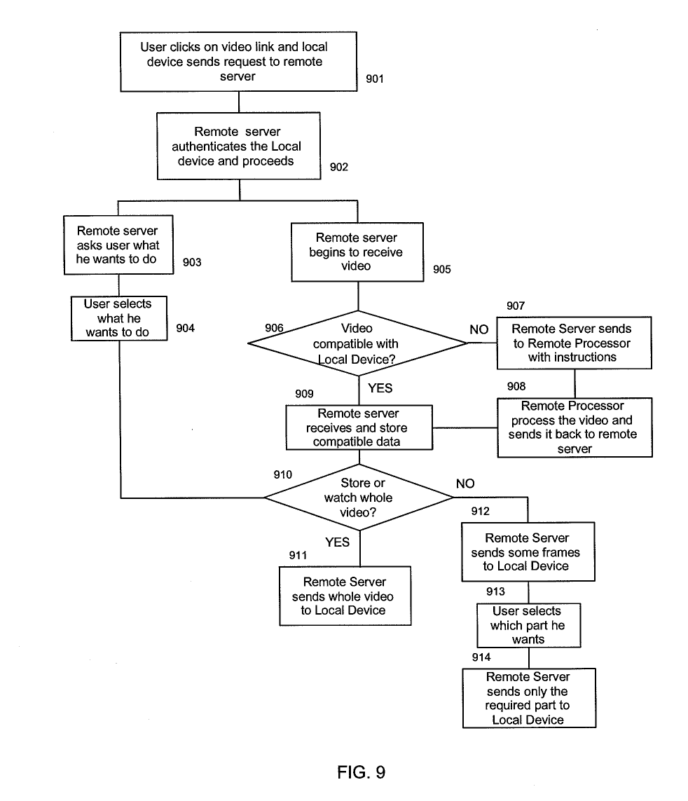

A second example, shown in FIG. 9, is when a user clicks on a link to download a video and the request is sent to the remote server by the local device (901). The remote server receives the request, authenticates the user and proceeds (902). At this moment, the remote server asks the user (903) if he or she wants to save it (if the local device allows it), watch it on the fly or view a preview of the video (some frames) to decide which part of it he wants to access. In the preview of the video, the user will access some images that will correspond to frames. While waiting for the user to answer, the remote server begins to receive the video from the web (905). If it is not compatible or not optimized, the remote server begins to send it to the remote processor as it receives it (907). The remote processor processes it upon reception and sends it back to the remote server (908).

If the user wants to watch or save the video, the remote server sends it directly to the local device. If the user wants to see the video, it will open as soon as it begins to receive it, without the need to download the whole video to begin watching it. If the user wants to receive a preview, the remote server sends some frames, in image format, to the local device (912). The remote server stores the rest of the compatible video that is not sent to the local device in order to send it later. The user selects the part of the video he wants to see (913) and send the request to the remote server. The remote server sends the selected part of the video and it will be displayed in the local device upon reception (914).

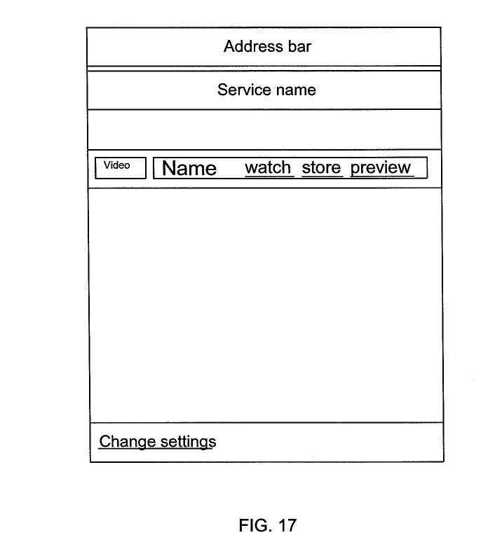

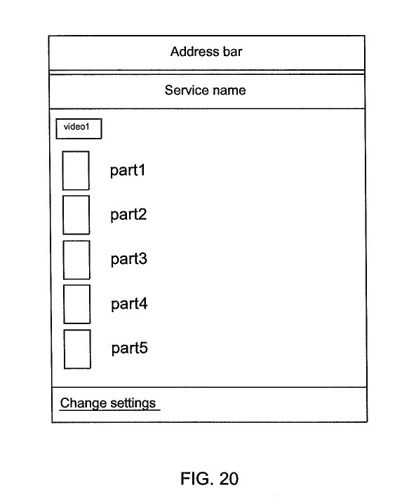

In the case of downloading a video, the user will interact with the service. In the first moment, when the remote server asks him/her whether the user wants to download the whole movie, store the whole movie or select only a part of it to watch. FIG. 17 illustrates the screen the user will see. It contains the address bar of the browser, the name of the service and 4 options: watch, store, preview and change settings. Each option will have a link in order to allow the user to select it. If the user selects watch or store, he/she will receive the video. If the user selects to watch it, he/she will watch as it receives it, not being necessary to download all the video in order to watch it. If it selects the “preview” option, the webpage will change to a list of images on the left side with a link on the right to enable the user to select which part he desires. When the user clicks on it, he/she will receive the selected part of the video and watch it. An example of a GUI for this type of option is shown in FIG. 20. If the user clicks on change settings, he/she will be able to change parameters, such as image and video qualities and resolution, default parameters, etc. If the user selects it, another screen will open where he/she will set up the new preferences.

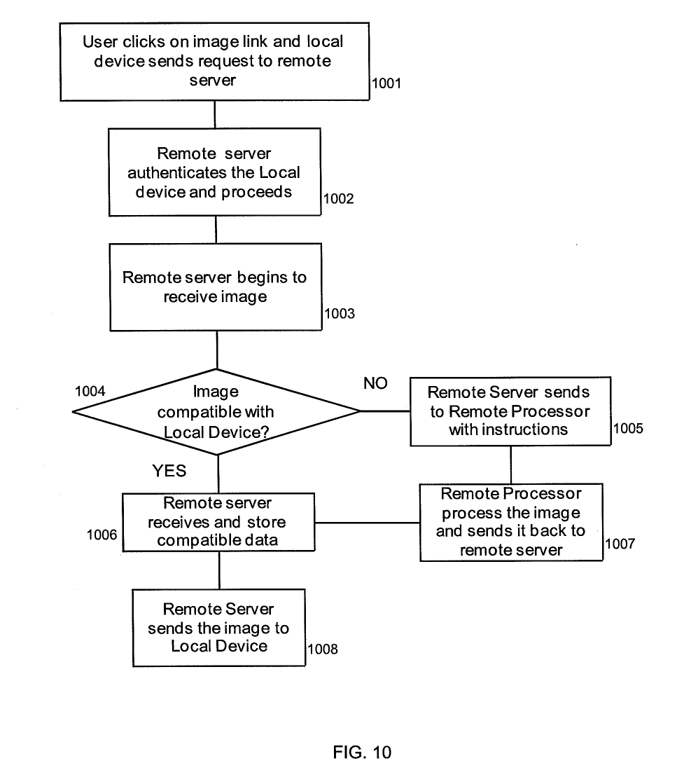

A third example, shown in FIG. 10, is when a user clicks on a link to download an image and the request is sent to the remote server by the local device (1001). The remote server receives the request, authenticates the user and proceeds (1002). The remote server begins to receive the image from the web (1003). If it is in a compatible format and optimized resolution, the remote server sends it directly to the local device (1006). If it is not compatible or not optimized, the remote server begins to send it to the remote processor as it receives it (1005). The remote processor processes it as it receives it and sends it back to the remote server (1007), which will send to the local device in compatible format and resolution. In this case, the local device's user will navigate through the internet normally, without any changes, besides the increase of speed.

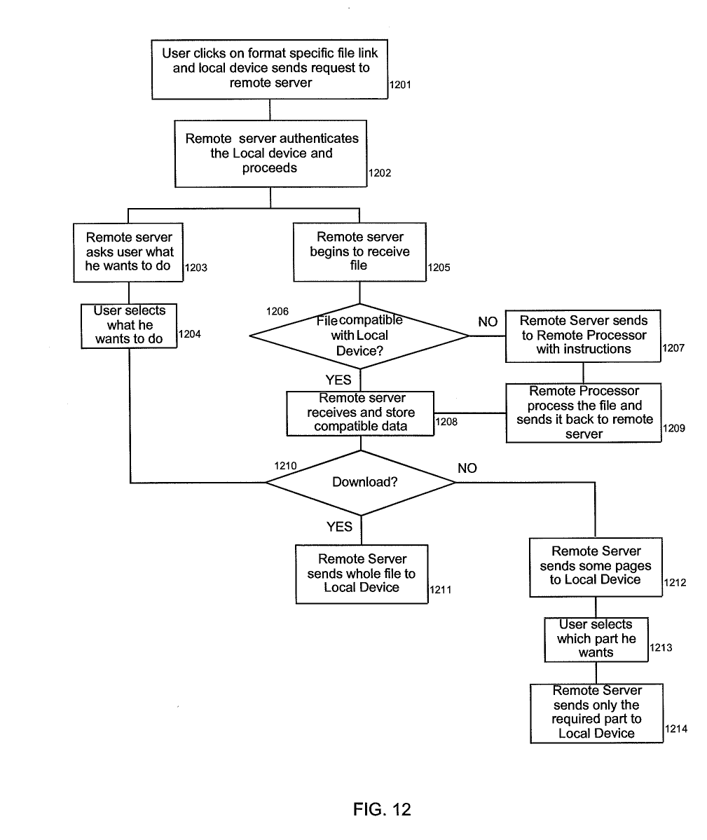

A forth example, shown in FIG. 12 is when a user tries to download a specific software format file (doc, pdf, xls, mpp, etc) and the request is sent to the remote server by the local device (1201). The remote server receives the request, authenticates the user and proceeds (1202). At this moment, the remote server asks the user if he or she wants to download it (to store or watch it) or view a preview of the data (some pages, instead of the whole document) to decide which part of it he wants to see (1203). In the last case, the user will have some images that will correspond to some pages. The remote server begins to receive the file from the web (1205). If it is not compatible with local device, the remote server begins to send it to the remote processor as it receives it (1207). The remote processor processes it as it receives it and sends it back to the remote server (1208).

If the user wants to download the file, the remote server sends it directly to the local device (1211). If the user wants to receive a preview, the remote server sends only parts of the file (some pages, for example), in image format, to the local device (1212). The user selects the part of the document he wants to download (1213) and send the request to the remote server. The remote server sends the required part to the local device (1214).

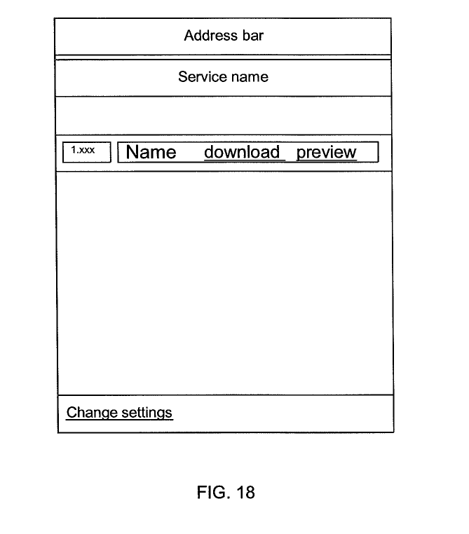

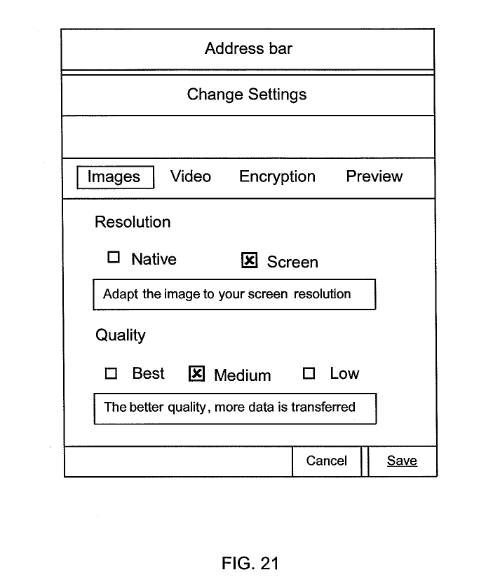

In the case of downloading a software specific format file, the user will interact with the service. In the first moment, when the remote server asks him/her whether he/she wants to download or store the whole file or select only a part of it. FIG. 18 illustrates one possible GUI the user will see. It contains the address bar of the browser, the name of the service and 3 options: download, preview and change settings. Each option will have a link in order to allow the user to select it. If the user selects download, he/she will receive the whole file. If it selects the “select a part” option, the webpage will change to a list of images on the left side with a link on the right to enable the user to select it. When the user clicks on it, he/she will receive the file. If the user clicks on change settings, he/she will be able to change parameters, such as image and video qualities and resolution, default parameters, etc. If the user selects it, another screen will open where he/she will set up the new preferences. FIG. 21 illustrates one possible GUI the user will see.

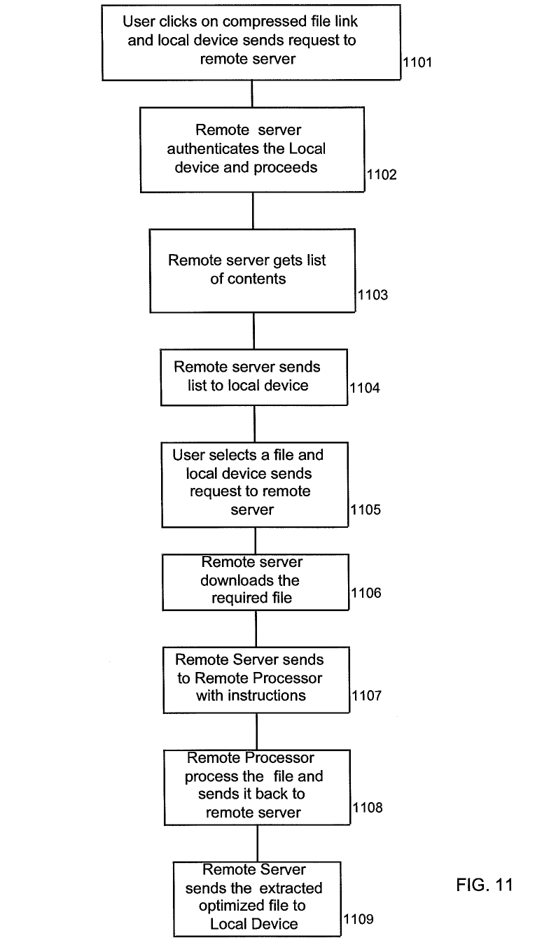

A fifth example, shown in FIG. 11, is when a user clicks on a link to download a compressed file and the request is sent to the remote server by the local device (1101). The remote server receives the request, authenticates the user and proceeds (1102). The remote server tries to extract only a list of the files contained in the compressed file without downloading it (1103). Most of web servers nowadays allow this kind of operation. If this is not possible, remote server downloads the whole file. The remote server forwards to the user a webpage with a list of the file contents (1104). The user selects a file and sends request to the remote server (1105). The remote server receives the request, downloads only the selected file (1106) and sends it to the remote processor as it receives it (1107). The remote processor uncompresses the file and sends it back to remote server that will send it to the local device. The remote processor returns the uncompressed and optimized file to the remote server (1108) and the remote server sends the extracted and optimized file to the Local device (1109).

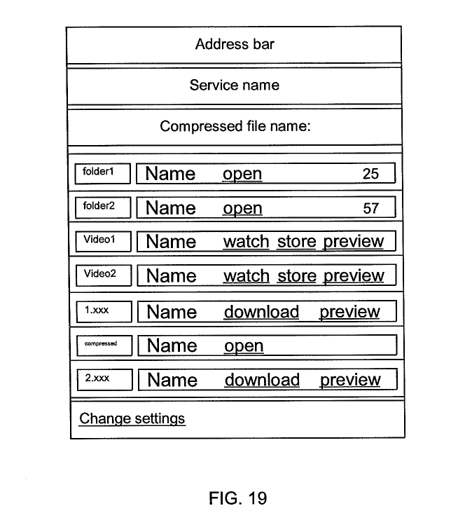

In the case of downloading a compressed file, the user will also interact with the service. When the remote server sends a list of the contents the user will have to select one. An example of such a list is shown in FIG. 19 and contains icons and links to allow the user to select the desired option. If the files are videos or specific format software files, all the optimization options described above will be present for these files. If there is a folder or another compressed file, the user will be able to see immediately the number of contents inside and explore it.

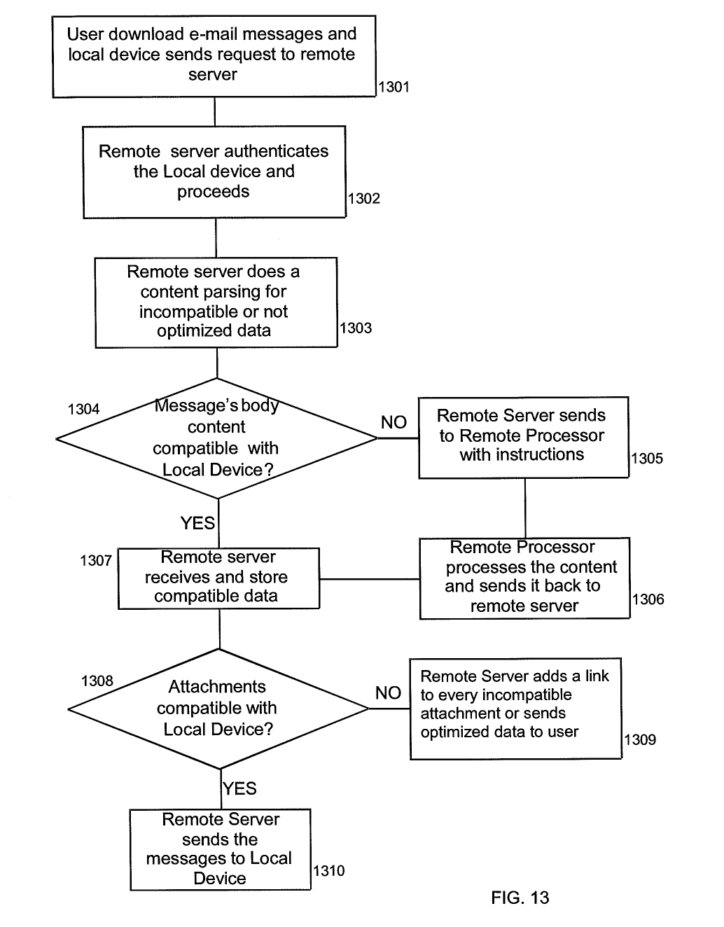

A sixth example is shown in FIG. 13, where a user is downloading his/her e-mail messages via e-mail protocols, such as POP or IMAP. The local device requests e-mail messages (1301), the remote server receives the request, authenticates the user and proceeds (1302). The remote server checks attachments and does a content parsing for incompatible data (1303). If nothing incompatible is found, the remote server sends it directly to the local device. If there is some incompatible content in the message's body, this content is treated as it was in a webpage (first example). If it's an attachment, the remote server will add one link to every incompatible attachment (1309) or replace the attachment directly by a compatible (optimized) file, according to users' settings. If a link is added, when the user clicks on it, it will be treated as any of the previous cases (2^{nd}, 3^{rd}, 4^{th} or 5^{th} examples).

A seventh example is show in FIG. 15, where a user is accessing his files on a remote backup system, such as SOONR, MOBILE ME, IDrive, HP Upline etc. Those files are stored in a server over the internet and are accessible to any local device through the browser. The local device requests the service URL and selects the file it wants to access. The remote server authenticates the user and start the process according to the file type (video, document, image etc).

While the invention has been described in connection with certain preferred embodiments, it is not intended to limit the spirit or scope of the invention to the particular forms set forth, but is intended to cover such alternatives, modifications, and equivalents as may be included within the true spirit and scope of the invention as defined by the appended claims.

What is claimed is:

1. A system for remote and real-time data processing comprising:
a) a local device;
b) a remote server;
c) a remote processor;
d) the network; and
e) data to be optimized,
wherein:
the local device's data access is done via the remote server; and
the remote processor performs optimization to deliver the data to the local device in an optimized format.

2. The system according to claim 1, wherein the local device is a device with limited processing capabilities.

3. The system according to claim 2, wherein the local device is chosen from the group consisting of desktop computers, notebooks, netbooks, smartphones cell phones and combinations thereof.

4. The system according to claim 1, wherein the remote server is scalable in order to comprise multiple remote server instances.

5. The system according to claim 4, wherein a remote server instance is optimized to handle as many users as possible simultaneously.

6. The system according to claim 4, wherein the multiple remote server instances are controlled by a controlling unit.

7. The system according to claim 1, wherein the remote server comprises a cache to store frequently accessed content and/or most accessed webpages.

8. The system according to claim 7, wherein the cache has a caching storing algorithm.

9. The system according to claim 7, wherein the caching storing algorithm correlates the storage space available, the computing resources necessary and the amount of users accessing the same content.

10. The system according to claim 7, wherein the cache stores the final processed data.

11. The system according to claim 7, wherein the cache stores the intermediate processed data.

12. The system according to claim 1, wherein the remote processor is an equipment with enough processing power to execute the tasks requested by the user of the local device in an adequate amount of time.

13. The system according to claim 12, wherein the remote processor is a stream processor with high performance computing technologies selected from the group consisting of FPGAs, GPUs, multicore processors, ASICs and combinations thereof.

14. The system according to claim 12, wherein the remote processor is associated with a remote server instance.

15. The system according to claim 12, wherein the remote processor changes it states to overcome lack of resources.

16. The system according to claim 1, wherein the remote processor processes most demanded data to other devices when idle, even before a user's request.

17. The system according to claim 1, wherein the remote server detects changes in most accessed content over the network and sends it remote processor before a user's request.

18. The system according to claim 1, wherein the remote processor is disabled when idle to reduce power consumption.

19. The system according to claim 1, wherein the remote processor processes data in an efficient way in order to maximize the number of users per remote processor.

20. The system according to claim 1, wherein the remote processor is also scalable supporting the addition of FPGAs, GPUs, ASICs and multicore processors.

21. The system according to claim 1, wherein the data to be optimized is information that can be accessed by the local device, over a network.

22. The system according to claim 1, comprising a billing system linked to the user access to the optimization system.

23. The system according to claim 1, wherein the access protocol is chosen from the group consisting of HTTP, HTTPS, FTP, IMAP, POP and combinations thereof.

24. The system according to claim 1, wherein the data to be optimized is chosen from the group consisting of documents, pictures, videos, websites, compressed files, e-mails, music and combinations thereof.

25. The system according to claim 1, wherein the download, optimization and sending of data is performed in a pipelined way.

26. The system according to claim 1, further comprising a video comparator to avoid storing and processing the same file twice.

27. A method for remote and real-time data processing comprising the steps of:
a) sending a local device's data request to a remote server;
b) the remote server forwards the request to the network and waits for the response; and
c) optimization of the response, containing the data, by processing it on the remote processor and sending to the local device the optimized data by the remote server,
wherein the sending of information is done in real-time with the optimization.

28. The method, according to claim 27, wherein the remote server sends a command to force the local device to change its original request to one including a optimized data format in order to allow the local device to receive the information correctly upon reception of the optimized data.

29. The method, according to claim 28, further comprising the steps of:
a) the local device sends request to the remote server;
b) the remote server receives the request, forwards it to the network; and
c) the remote server sends an HTML command to the local device in other to refresh its request to prepare it to receive the right content format.

30. The method according to claim 27, wherein the request is mainly composed by the location to find the desired data.

31. The method according to claim 27, wherein the optimization to be done depends on the kind of data.

32. The method according to claim 31, wherein the data is chosen from the group consisting of documents, pictures, videos, websites, compressed files, e-mails, music and combinations thereof.

33. The method according to claim 27, wherein the access protocol is selected from the group consisting of HTTP, HTTPS, FTP, IMAP, POP and combinations thereof.

34. The method according to claim 31, wherein the optimization process is chosen from the group consisting of video conversion (format and resolution) and streaming, encryption, compression and decompression, virus scan, network enhancer, firewall, image processing, 3^{rd} party applications, preview of files, and files conversion.

35. the method according to claim 27, wherein the user may preview the data to be optimized in order to save processing resources and bandwidth.

36. The method according to claim 35, wherein the preview can be made in video files, compressed files and any documents.

37. The method according to claim 34, wherein the user can select which file to be extracted and optimized from compressed files.

38. The method according to claim 27, wherein the channel by which the request is made and the optimized data is sent back to the local device is chosen from the group consisting of regular telephone grade modems, cable modems and DSL modems, ISDN adapters, Ethernet cards, cellular telephone communications systems, wireless networking systems and combinations thereof.

39. The method according to claim 27, wherein a billing system is linked to a user's access to the optimization system.
